(19) United States
(12) Patent Application Publication
(10) Pub. No.: US 2012/0166647 A1
(43) Pub. Date: Jun. 28, 2012

(54) APPARATUS FOR CONFIGURING VIRTUAL NETWORK USING NETWORK VIRTUALIZATION TECHNIQUE AND METHOD THEREOF

(75) Inventors: Ki Hyuk NAM, Daejeon (KR); Sang Jin JEONG, Daejeon (KR); Myung Ki SHIN, Daejeon (KR); Hyoung Jun KIM, Daejeon (KR)

(73) Assignee: Electronics and Telecommunications Research Institute, Daejeon (KR)

(21) Appl. No.: 13/334,353

(22) Filed: Dec. 22, 2011

(30) Foreign Application Priority Data
Dec. 23, 2010 (KR) 10-2010-0134077

(51) Int. Cl. G06F 15/173

(52) U.S. Cl. 709/226

(57) ABSTRACT

Provided are an apparatus for configuring a virtual network using a network virtualization technique, and a method thereof according to the present invention. The apparatus for configuring a virtual network and method according to present invention may construct a virtual network capable of guaranteeing a desired network characteristic during a predetermined period using a resource provided from at least one platform according to a mutual interaction policy of a platform.

### CROSS-REFERENCE TO RELATED APPLICATIONS

This application claims priority to and the benefit of Korean Patent Application No. 10-2010-0134077 filed in the Korean Intellectual Property Office on Dec. 23, 2010, the entire contents of which are incorporated herein by reference.

### TECHNICAL FIELD

The present invention relates to a network virtualization technique, and more particularly, to an apparatus for configuring a virtual network using a network virtualization technique in which a web user having a predetermined qualification and right is enabled to construct a virtual network capable of guaranteeing a desired network characteristic during a predetermined period using a resource provided from at least one platform according to a mutual interaction policy of a platform, and a method thereof.

### BACKGROUND ART

Currently, it is in complete agreement that that the Internet has made great contributions to connecting the whole world and making it possible to quickly and easily share information. However, recently, there is an increasing demand on various characteristics such as security, performance, and the like, which is not currently optimized for the Internet, such as a private network for a company, a messenger service, a peer to peer (P2P) service exchanging large data, an online desktop service, various social network services, and the like.

To construct a desired function through network virtualization is considered as a realistic alternative rather than using a physical dedicated line and thus, various research institutions and companies have studied various network virtualization techniques and constructed a platform. Here, the network virtualization technique refers to a technique that enables a plurality of logically separate networks to coexist based on a shared network apparatus.

When the network virtualization technique is applied, various virtual networks are dynamically constructed on a single physical network. While each of the virtual networks is performing a function of a special goal, resources between the virtual networks operate while being isolated and thus, does not affect each other and interaction of the virtual networks is also performed if necessary.

However, even though the Internet currently guarantees a general-purpose connectivity between each other, there is a need to configure a predetermined private network depending on cases, due to various requirements such as security, performance guarantee, and the like.

### SUMMARY OF THE INVENTION

The present invention has been made in an effort to provide an apparatus for configuring a virtual network using a network virtualization technique in which a web user having a predetermined qualification and right is enabled to construct a virtual network capable of guaranteeing a desired network characteristic during a predetermined period using a resource provided from at least one platform according to a mutual interaction policy of a platform, and a method thereof.

An exemplary embodiment of the present invention provides a virtualization platform for configuring a virtual network, the virtualization platform including: a virtual network connecting port to generate a virtual network profile in which a characteristic of a virtual network desired by a user of a user terminal is reflected, when the user terminal is connected; a resource managing device to manage a physical resource and a virtual resource; a virtual network managing device to generate the virtual network based on the virtual network profile, and to request a detailed interaction procedure of the generated virtual network; and a network interaction controlling device to allocate and install the physical resource and the virtual resource as a constituent element specified in the virtual network profile in response to the request for the detailed interaction procedure.

When the user terminal is connected, the virtual network connecting port may perform user authentication through a certificate of the connected user terminal, and when the user authentication succeeds, the virtual network connecting port may generate the virtual network profile in which the characteristic of the virtual network desired by the user is reflected and then transfer the generated virtual network profile to the virtual network managing device.

The physical resource may indicate a resource that is directly connected to the virtualization platform, and the virtual resource may indicate a resource that is provided through a virtual machine monitor.

The virtual network managing device may verify whether a resource is available based on the virtual network profile and inspect whether the virtual network desired by the user is a duplicate of an existing virtual network at the same level and then generate the virtual network based on the inspection result to request the network interaction controlling device for the detailed interaction procedure of the virtual network.

The network interaction controlling device may allocate and install the physical resource and the virtual resource as the constituent element specified in the virtual network profile and return the processing result to the virtual network managing device.

The network interaction controlling device may verify whether there is a constituent element not equipped in a current virtualization platform by analyzing the virtual network profile. When there is no constituent element not equipped as the verification result, the network interaction controlling device may allocate and install the physical resource and the virtual resource as the constituent element specified in the virtual network profile and may return the processing result to the virtual network managing device.

When there is the constituent element not equipped as the verification result, the network interaction controlling device may verify whether a network interaction adaptor is equipped as a connection interface with respect to an external virtualization platform. When the network interaction adaptor is equipped, the network interaction controlling device may allocate and install the physical resource and the virtual resource as the constituent element specified in the virtual network profile and may return the processing result to the virtual network managing device.

When the network interaction adaptor is not equipped, the network interaction controlling device may install the network interaction adaptor and then may allocate and install the physical resource and the virtual resource as the constituent element specified in the virtual network profile and may return the processing result to the virtual network managing device.

Another exemplary embodiment of the present invention provides a method for configuring a virtual network using a network virtualization technique, the method including: generating a virtual network profile in which a characteristic of a virtual network desired by a user of a user terminal is reflected, when the user terminal is connected; generating the virtual network based on the virtual network profile, and requesting a detailed interaction procedure of the generated virtual network; and allocating and installing a physical resource and a virtual resource as a constituent element specified in the virtual network profile in response to the request for the detailed interaction procedure.

The generating may include: performing user authentication through a certificate of the connected user terminal when the user terminal is connected; and generating the virtual network profile in which the characteristic of the virtual network desired by the user is reflected and then transferring the generated virtual network profile to a virtual network managing device, when the user authentication succeeds.

The physical resource may indicate a resource that is directly connected to the virtualization platform, and the virtual resource may indicate a resource that is provided through a virtual machine monitor.

The requesting may include: verifying whether a resource is available based on the virtual network profile and inspecting whether the virtual network desired by the user is a duplicate of an existing virtual network at the same level; and generating the virtual network based on the inspection result to request a network interaction controlling device for the detailed interaction procedure of the virtual network.

The allocating and the installing may include: verifying whether there is a constituent element not equipped in a current virtualization platform by analyzing the virtual network profile, in response to the request for the detailed interaction procedure; and allocating and installing the physical resource and the virtual resource as the constituent element specified in the virtual network profile, when there is no constituent element not equipped as the verification result.

The allocating and the installing may include: verifying whether there is a constituent element not equipped in a current virtualization platform by analyzing the virtual network profile, in response to the request for the detailed interaction procedure; verifying whether a network interaction adaptor is equipped as a connection interface with respect to an external virtualization platform, when there is the constituent element not equipped as the verification result; and allocating and installing the physical resource and the virtual resource as the constituent element specified in the virtual network profile, when the network interaction adaptor is equipped.

The allocating and the installing may include: verifying whether there is a constituent element not equipped in a current virtualization platform by analyzing the virtual network profile, in response to the request for the detailed interaction procedure; verifying whether a network interaction adaptor is equipped as a connection interface with respect to an external virtualization platform, when there is the constituent element not equipped as the verification result; installing the network interaction adaptor when the network interaction adaptor is not equipped; and allocating and installing the physical resource and the virtual resource as the constituent element specified in the virtual network profile.

According to exemplary embodiments of the present invention, a web user having a predetermined qualification and right is enabled to construct a virtual network capable of guaranteeing a desired network characteristic during a predetermined period using a resource provided from at least one platform according to a mutual interaction policy of a platform and thus, it is possible to configure the virtual network in a form desired by a user at various levels.

According to exemplary embodiments of the present invention, a web user having a predetermined qualification and right is enabled to construct a virtual network capable of guaranteeing a desired network characteristic during a predetermined period using a resource provided from at least one platform according to a mutual interaction policy of a platform and thus, it is possible to automatically generate the desired virtual network through a web interface without going through a complex procedure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exemplary diagram to describe a principle of configuring a virtual network according to an exemplary embodiment of the present invention.

FIG. 2 is a first exemplary diagram illustrating a detailed configuration of a virtualization platform 200 of FIG. 1.

FIG. 3 is a first exemplary flowchart illustrating a method of configuring a virtual network according to an exemplary embodiment of the present invention.

FIG. 4 is a second exemplary diagram illustrating a detailed configuration of the virtualization platform 200 of FIG. 1.

FIG. 5 is a second exemplary flowchart illustrating a method of configuring a virtual network according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

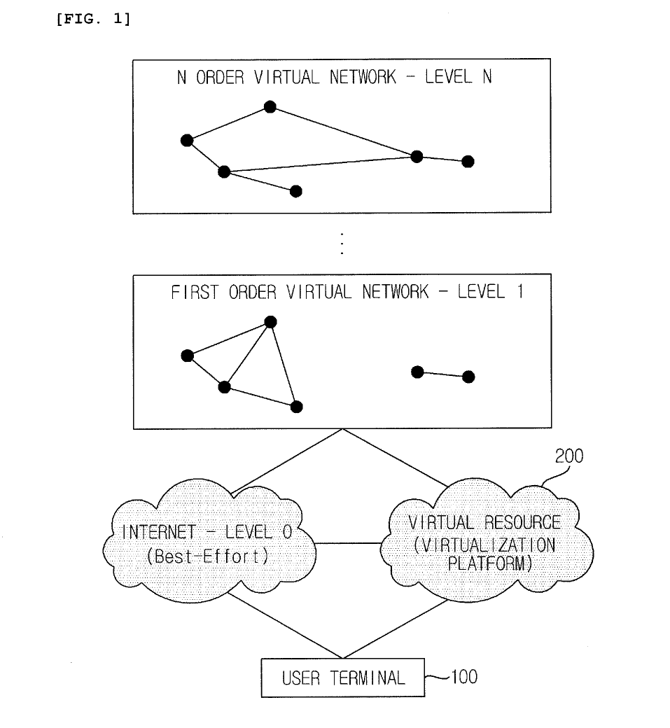

Hereinafter, a virtualization platform for configuring a virtual network using a network virtualization technology and a method thereof according to exemplary embodiments of the present invention will be described in detail with reference to the accompanying FIGS. 1 to 5. Description will be made in detail based on a portion that is required to understand operations and effects according to the present invention.

The present invention proposes a virtualization platform in which a web user having a predetermined qualification and right is enabled to construct a virtual network capable of guaranteeing a desired network characteristic, for example, security, a response speed, a bandwidth, and the like, during a predetermined period using a network resource provided from at least one virtualization platform according to a mutual interaction of a virtualization platform.

FIG. 1 is an exemplary diagram to describe a principle of configuring a virtual network according to an exemplary embodiment of the present invention.

As shown in FIG. 1, the present invention may configure various levels of virtual networks using an existing Internet network or a physical network. That is, a network virtualization platform (hereinafter, referred to as a virtualization platform) configures a predetermined virtual network in an Internet network using various physical devices.

When a single virtual network is configured, a new level of a virtual network is configured again based on the configured virtual network. From a user perspective, there exists another single virtual network isolated from the existing Internet network or other virtual networks.

The virtual network may use a resource of the existing Internet network and may also use a resource of the virtualization platform. The virtual network may use a mixed resource by mixing the resource of the existing Internet network and the resource of the virtualization platform.

As described above, the virtual network according to the present invention may be configured based on a physical resource provided from the existing Internet network and a virtual resource provided from the virtualization platform and may also construct an upper level of another network based on the existing virtual network configured as above.

For example, 1) a TCP_{—}1/IP_{—}1 network that is a new second order virtual network is configured by configuring a TCP_{—}1 network based on an IP_{—}1 network that is a first order virtual network. Here, an inter-level virtual network is prevented from being infinitely generated by preventing an IP_{—}2 network at the same level as the IP_{—}1 network from being repeatedly generated.

2) It is possible to configure a TCP_{—}1/IP_{—}2 network by changing a lower level of the first order virtual network IP_{—}1 to the new IP_{—}2 network without affecting a terminal or a user in the existing second order virtual network.

3) It is possible to generate a virtual network including at least two networks. That is, it is possible to configure a TCP_{—}1/IP_{—}1+IP_{—}2 network that is a second order virtual network including the IP_{—}1 network and the IP_{—}2 network as the first order virtual network.

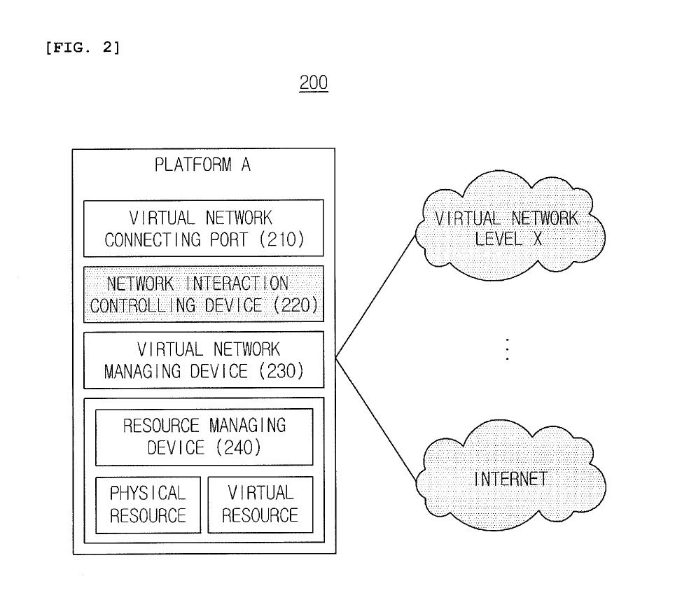

FIG. 2 is a first exemplary diagram illustrating a detailed configuration of a virtualization platform 200 of FIG. 1.

As shown in FIG. 2, the virtualization platform 200 according to an exemplary embodiment of the present invention may include a virtual network connecting port 210, a network interaction controlling device 220, a virtual network managing device 230, a resource managing device 240, and the like.

The virtual network connecting port 210 converts a characteristic of a network desired by a user to a virtual network profile in a form that can be processed by the virtual network managing device 230. Attributes recorded in the virtual network profile include various items such as a network configuration participant or node, a security level, an optimal secured bandwidth, a response speed, and the like. The number of items included in the virtual network profile is extendible.

The virtual network connecting port 210 has an authentication function of inspecting a right to approach the virtualization platform 200 and to generate a virtual network. Accordingly, the user is enabled to perform user authentication through a certificate suitable for the corresponding authentication function and to access the virtualization platform 200 as the result of the user, authentication, thereby automatically checking and allocating a virtual resource and a physical resource and generating a path for the virtual network.

The resource managing device 240 manages a physical resource such as a central processing unit (CPU) directly connected to the virtualization platform 200, a network card, a storage, and the like, and a virtual resource that is provided through a virtual machine monitor (VMM), and allocates the physical resource and the virtual resource to the user and returns the processing result, and monitors a current available resource state.

The virtual network managing device 230 generates a virtual network requested by the user, checks a resource from a node configured as a physical server, that is, the resource managing device 220, and allocates the resource as a constituent element of the virtual network requested by the user. The virtual network managing device 230 monitors a state in which the user is using the virtual network. When the usage of the user is completed, the virtual network managing device 230 deletes the virtual network and returns the resource allocated therein.

When generating the virtual network, the virtual network managing device 230 configures a specific resource based on the virtual network profile transferred from the user, and sets a communication scheme between nodes constituting the virtual network, performance restrictions, and the like. A detailed technique of connecting virtual nodes may use various future transmission and network layer techniques not to mention of various existing techniques including a virtual local area network (VLAN), a tunneling, and the like.

The virtual network managing device 230 functions to simply generate the virtual network and to allocate a resource. The virtual network managing device 230 functions to completely separate a concept of an upper level of a virtual network and a specific lower technique for substantially realizing the same.

The virtual network managing device 230 functions to realize a network configuration rule such as a rule of recording a current state of a physical resource and a virtual resource being used in a current virtual node, that is, a level of a virtual network that is using the physical resource and the virtual resource, and thereby preventing the level from increasing infinitely or preventing a focus on a resource already allocated and being used when a new network configuration request is received.

The network interaction controlling device 220 allocates and installs the constituent element of the virtual network, for example, a software platform, routing, various network protocol stacks, and the like, based on the virtual network profile that is transferred from the user.

To efficiently realize a process of generating at least second order virtual network, the network interaction controlling device 220 may skip one level as necessary instead of sequentially following a constituent element of a virtual network of a lower level. For example, the network interaction controlling device 220 may directly approach a constituent element of a first order virtual network from a constituent element of a third order virtual network. However, from the point of view of a user and a manager of the virtual network, logical consistency is maintained through expression suitable for a level of a corresponding virtual network.

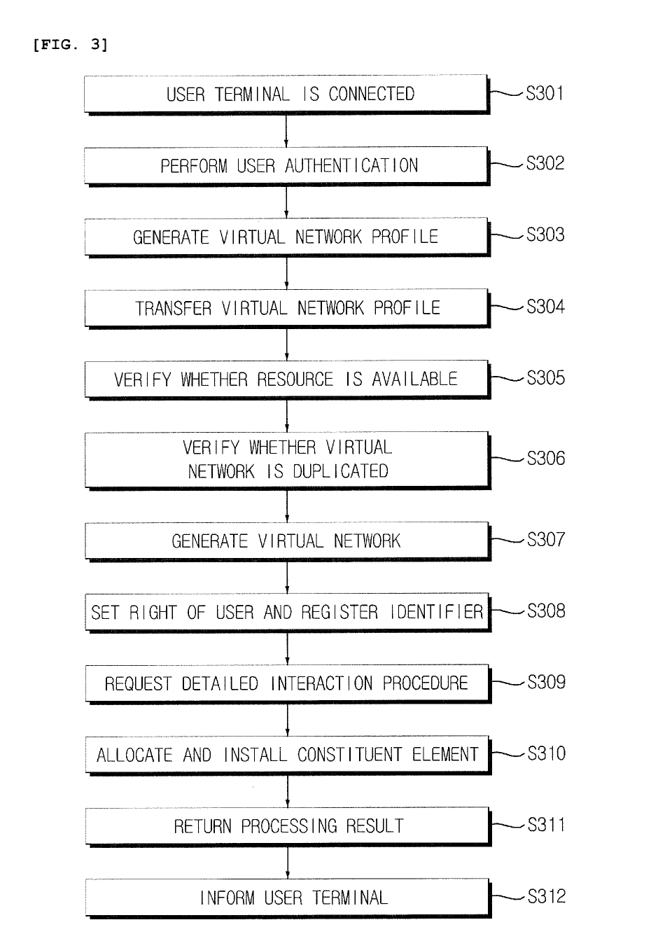

FIG. 3 is a first exemplary flowchart illustrating a method of configuring a virtual network according to an exemplary embodiment of the present invention.

As shown in FIG. 3, when a user terminal is connected (S301), a virtual network connecting port according to the present invention performs user authentication through a certificate of the connected user terminal (S302).

Here, when the user authentication succeeds, the user terminal may check a current state of a virtual network, for example, a currently available virtual network, a current resource state of a physical resource and a virtual resource, and the like.

Next, when the user authentication succeeds, the virtual network connecting port generates a virtual network profile in which a characteristic of a virtual network desired by a user is reflected (S303), and transfers the generated virtual network profile to a virtual network managing device (S304).

Next, the virtual network managing device verifies whether a resource is available based on the virtual network profile (S305), and inspects whether the virtual network desired by the user is a duplicate of an existing virtual network, in order to prevent a network of the same level from being constructed (S306).

Next, the virtual network managing device generates a new virtual network based on the inspection result (S307), and sets a right of the user to the generated virtual network and registers an identifier (S308).

Next, the virtual network managing device requests a network interaction controlling device for a detailed interaction procedure (S309).

Next, the network interaction controlling device allocates and installs a constituent element specified in the virtual network profile (S310) and returns the processing result to the virtual network managing device (S311).

Next, the virtual network managing device informs again the user terminal about the returned processing result (S312).

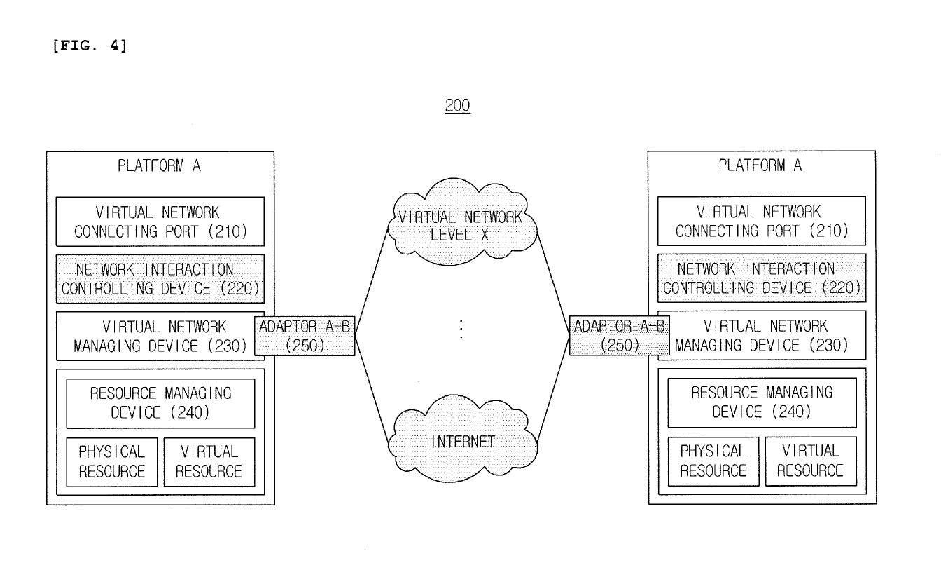

FIG. 4 is a second exemplary diagram illustrating a detailed configuration of the virtualization platform 200 of FIG. 1.

As shown in FIG. 4, the virtualization platform 200 according to the present invention may include the virtual network connecting port 210, the network interaction controlling device 220, the virtual network managing device 230, the resource managing device 240, a network interaction adaptor 250, and the like.

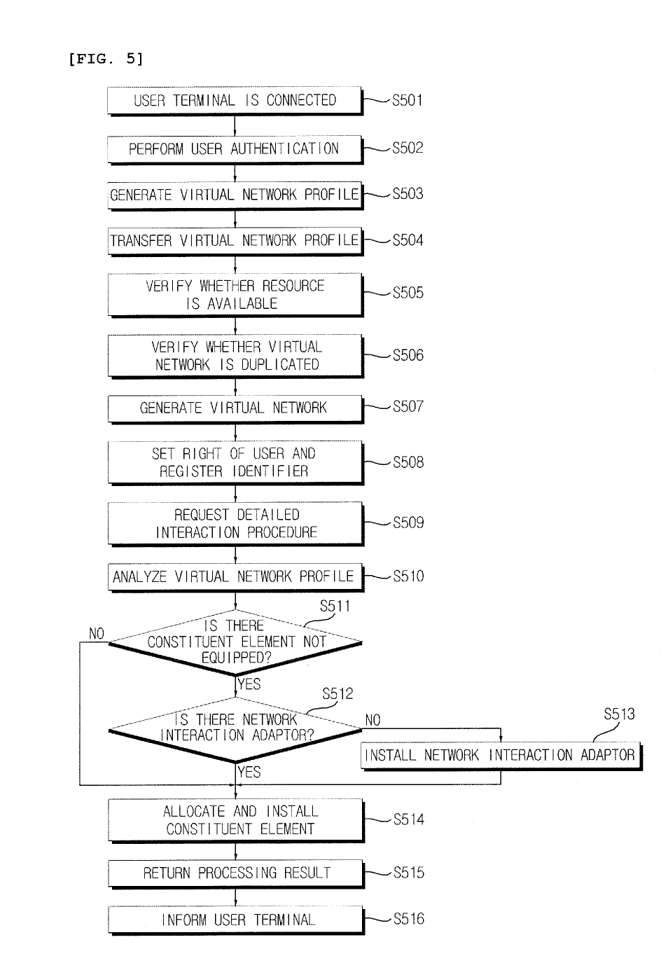

The virtualization platform 200 of FIG. 5 according to the present invention constructed as above has the same configuration and function as the virtualization platform 200 of FIG. 2. Only the network interaction adaptor 250 is added to the virtualization platform 200 of FIG. 5. Therefore, only a function associated with the added network interaction adaptor 250 will be described.

The network interaction controlling device 220 functions to enable a resource provided from a virtualization platform currently belonging and an external virtualization platform to be used as a constituent element of a virtual network requested by a user.

The network interaction controlling device 220 provides an interface capable of configuring various network protocol stacks as well as a software platform and routing required for a virtual node that constitutes the virtual network, and checking a current available resource state of a current virtualization platform and other virtualization platforms.

An interface between various virtualization platforms is processed through a network interaction adaptor 250. With respect to a new virtualization platform not equipped with an existing interface, interaction may be performed immediately by requesting the corresponding virtualization platform for the network interaction adaptor 250 before entering into a full interaction procedure, and by dynamically installing the network interaction adaptor 250.

FIG. 5 is a second exemplary flowchart illustrating a method of configuring a virtual network according to an exemplary embodiment of the present invention.

As shown in FIG. 5, when a user terminal is connected (S501), a virtual network connecting port according to the present invention performs user authentication through a certificate of the connected user terminal (S502).

Here, when the user authentication succeeds, the user terminal may check a current state of a virtual network, for example, a currently available virtual network, a current resource state of a physical resource and a virtual resource, and the like.

Next, when the user authentication succeeds, the virtual network connecting port generates a virtual network profile in which a characteristic of a virtual network desired by a user is reflected (S503), and transfers the generated virtual network profile to a virtual network managing device (S504).

Next, the virtual network managing device verifies whether a resource is available based on the virtual network profile (S505), and inspects whether the virtual network desired by the user is a duplicate of an existing virtual network, in order to prevent a network at the same level from being constructed (S506).

Next, the virtual network managing device generates a new virtual network based on the inspection result (S507), and sets a right of the user to the generated virtual network and registers an identifier (S508).

Next, the virtual network managing device requests a network interaction controlling device for a detailed interaction procedure (S509).

Next, the network interaction controlling device analyzes the virtual network profile (S510) to verify whether there is a constituent element not equipped in a current virtualization platform (S511). When there is no constituent element not equipped, the network interaction controlling device allocates and installs the constituent element specified in the virtual network profile (S514) and returns the result to the virtual network managing device (S515).

On the contrary, when there is the constituent element not equipped, the network interaction controlling device verifies whether a network interaction adaptor is equipped as a connection interface with respect to an external virtualization platform (S512).

Next, when the network interaction adaptor is equipped, the network interaction controlling device allocates and installs the constituent element specified in the virtual network profile (S514) and returns the processing result to the virtual network managing device (S515).

On the contrary, when the network interaction adaptor is not equipped, the network interaction controlling device installs the network interaction adaptor (S513) and then allocates and installs the constituent element specified in the virtual network profile (S514) and returns the processing result to the virtual network managing device (S515).

The virtual network managing device informs again the user terminal about the returned processing result (S516).

As described above, according to exemplary embodiments of the present invention, a web user having a predetermined qualification and right is enabled to construct a virtual network capable of guaranteeing a desired network characteristic during a predetermined period using a resource provided from at least one platform according to a mutual interaction policy of a platform and thus, it is possible to configure the virtual network in a form desired by a user at various levels, and it is possible to automatically generate the desired virtual network through a web interface without going through a complex procedure.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A virtualization platform for configuring a virtual network, the virtualization platform comprising:
a virtual network connecting port to generate a virtual network profile in which a characteristic of a virtual network desired by a user of a user terminal is reflected, when the user terminal is connected;
a resource managing device to manage a physical resource and a virtual resource;
a virtual network managing device to generate the virtual network based on the virtual network profile, and to request a detailed interaction procedure of the generated virtual network; and
a network interaction controlling device to allocate and install the physical resource and the virtual resource as a constituent element specified in the virtual network profile in response to the request for the detailed interaction procedure.

2. The virtualization platform of claim 1, wherein:
when the user terminal is connected, the virtual network connecting port performs user authentication through a certificate of the connected user terminal, and
when the user authentication succeeds, the virtual network connecting port generates the virtual network profile in which the characteristic of the virtual network desired by the user is reflected and then transfers the generated virtual network profile to the virtual network managing device.

3. The virtualization platform of claim 1, wherein the physical resource indicates a resource that is directly connected to the virtualization platform, and the virtual resource indicates a resource that is provided through a virtual machine monitor.

4. The virtualization platform of claim 1, wherein the virtual network managing device verifies whether a resource is available based on the virtual network profile and inspects whether the virtual network desired by the user is a duplicate of an existing virtual network at the same level and then generates the virtual network based on the inspection result to request the network interaction controlling device for the detailed interaction procedure of the virtual network.

5. The virtualization platform of claim 1, wherein the network interaction controlling device allocates and installs the physical resource and the virtual resource as the constituent element specified in the virtual network profile and returns the processing result to the virtual network managing device.

6. The virtualization platform of claim 1, wherein:
the network interaction controlling device verifies whether there is a constituent element not equipped in a current virtualization platform by analyzing the virtual network profile, and
when there is no constituent element not equipped as the verification result, the network interaction controlling device allocates and installs the physical resource and the virtual resource as the constituent element specified in the virtual network profile and returns the processing result to the virtual network managing device.

7. The virtualization platform of claim 6, wherein:
when there is the constituent element not equipped as the verification result, the network interaction controlling device verifies whether a network interaction adaptor is equipped as a connection interface with respect to an external virtualization platform, and
when the network interaction adaptor is equipped, the network interaction controlling device allocates and installs the physical resource and the virtual resource as the constituent element specified in the virtual network profile and returns the processing result to the virtual network managing device.

8. The virtualization platform of claim 7, wherein when the network interaction adaptor is not equipped, the network interaction controlling device installs the network interaction adaptor and then allocates and installs the physical resource and the virtual resource as the constituent element specified in the virtual network profile and returns the processing result to the virtual network managing device.

9. A method for configuring a virtual network using a network virtualization technique, the method comprising:
generating a virtual network profile in which a characteristic of a virtual network desired by a user of a user terminal is reflected, when the user terminal is connected;
generating the virtual network based on the virtual network profile, and requesting a detailed interaction procedure of the generated virtual network; and
allocating and installing a physical resource and a virtual resource as a constituent element specified in the virtual network profile in response to the request for the detailed interaction procedure.

10. The method of claim 9, wherein the generating comprises:
performing user authentication through a certificate of the connected user terminal when the user terminal is connected; and
generating the virtual network profile in which the characteristic of the virtual network desired by the user is reflected and then transferring the generated virtual network profile to a virtual network managing device, when the user authentication succeeds.

11. The method of claim 9, wherein the physical resource indicates a resource that is directly connected to the virtualization platform, and the virtual resource indicates a resource that is provided through a virtual machine monitor.

12. The method of claim 9, wherein the requesting comprises:
verifying whether a resource is available based on the virtual network profile and inspecting whether the virtual network desired by the user is a duplicate of an existing virtual network at the same level; and
generating the virtual network based on the inspection result and requesting a network interaction controlling device for the detailed interaction procedure of the virtual network.

13. The method of claim 9, wherein the allocating and the installing comprises:
verifying whether there is a constituent element not equipped in a current virtualization platform by analyzing the virtual network profile, in response to the request for the detailed interaction procedure; and
allocating and installing the physical resource and the virtual resource as the constituent element specified in the virtual network profile, when there is no constituent element not equipped as the verification result.

14. The method of claim 9, wherein the allocating and the installing comprises:
verifying whether there is a constituent element not equipped in a current virtualization platform by analyzing the virtual network profile, in response to the request for the detailed interaction procedure;
verifying whether a network interaction adaptor is equipped as a connection interface with respect to an external virtualization platform, when there is the constituent element not equipped as the verification result; and
allocating and installing the physical resource and the virtual resource as the constituent element specified in the virtual network profile, when the network interaction adaptor is equipped.

15. The method of claim 9, wherein the allocating and the installing comprises:
verifying whether there is a constituent element not equipped in a current virtualization platform by analyzing the virtual network profile, in response to the request for the detailed interaction procedure;
verifying whether a network interaction adaptor is equipped as a connection interface with respect to an external virtualization platform, when there is the constituent element not equipped as the verification result;
installing the network interaction adaptor when the network interaction adaptor is not equipped; and
allocating and installing the physical resource and the virtual resource as the constituent element specified in the virtual network profile.
